(19) United States
(12) Patent Application Publication
(10) Pub. No.: US 2006/0038333 A1
(43) Pub. Date: Feb. 23, 2006

(54) Explosion proof harmonic balancer

(76) Inventor: Shu Woody Hwang, Baldwin Park, CA (US)

Correspondence Address: Shu Woody Hwang, 345 Cloverleaf Drive, #C, Baldwin Park, CA, 91706, US

(21) Appl. No.: 10/893,700

(22) Filed: Aug. 23, 2004

(51) Int. Cl. F16M 1/00

(52) U.S. Cl. 267/259; 267/136

(57) ABSTRACT

A nodular iron inertia ring surrounding with heavy viscosity silicone fluid is designed and installed in the engine serpentine pulley system to absorb rotation vibration during engine operation. The sealed silicone fluid and inertia ring will not deteriorate or deform from high heat generated from engine high RPM and will extend the usage life forever. At present market, an elastic rubber is commonly installed on the pulley system. This elastic rubber will become harden and loss binding characters under constant high heat generated from engine.

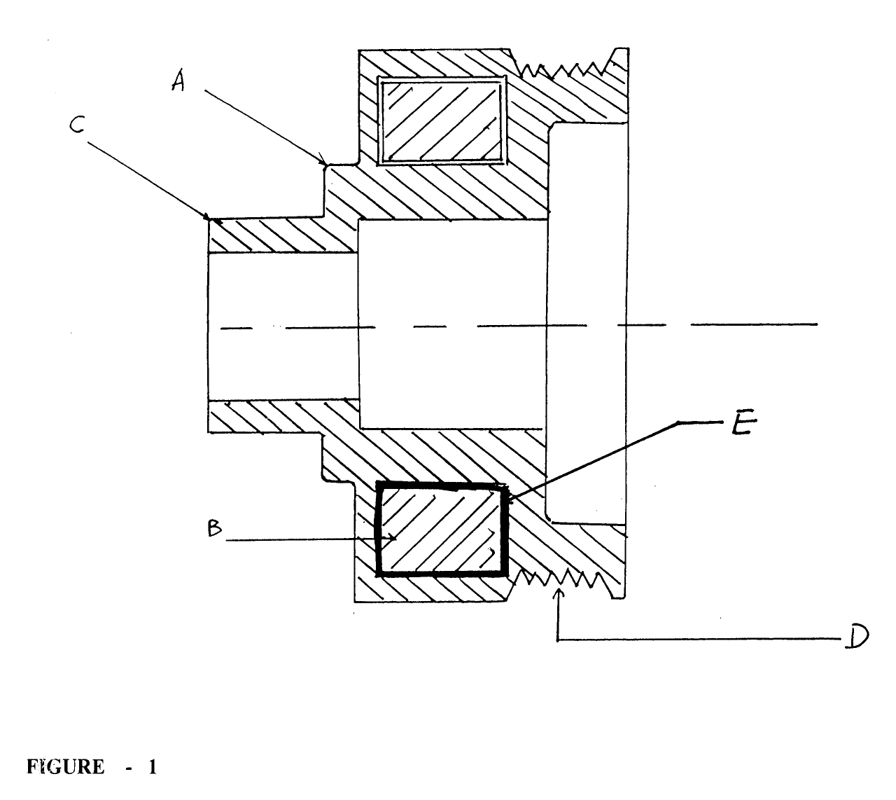

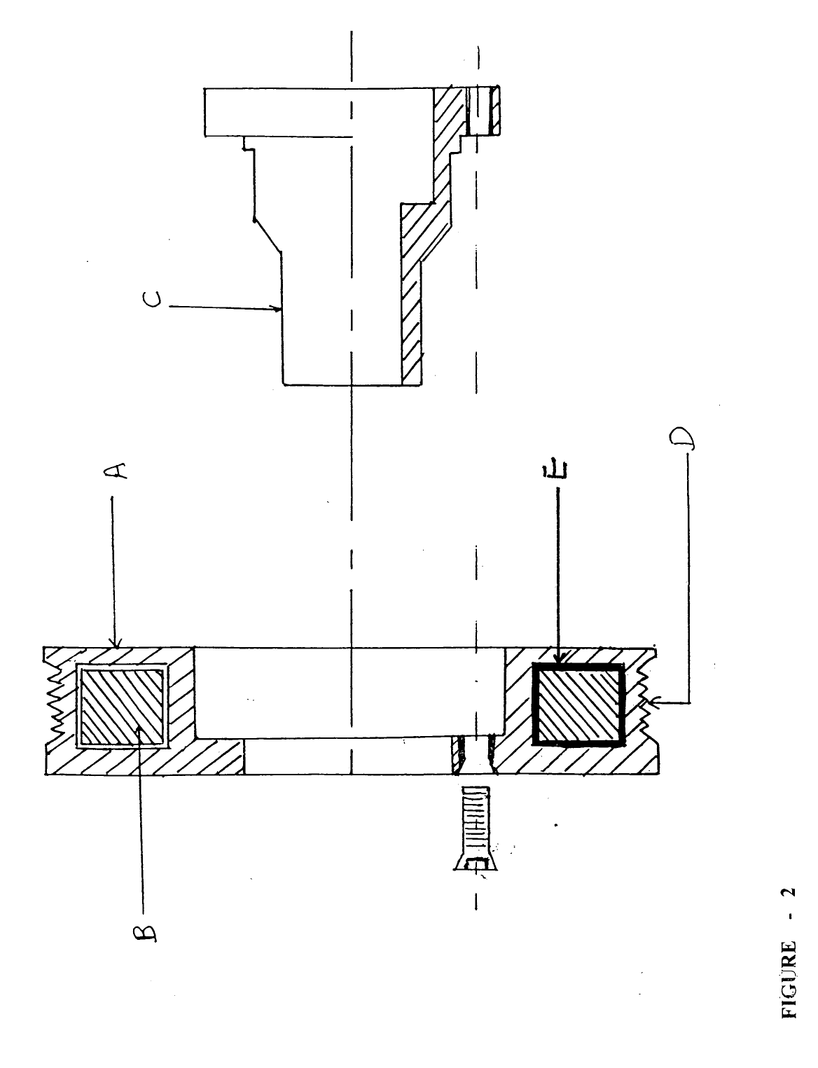

The vibration is a headache of engine builder. The only solution is to install a Harmonic Balancer at extreme end of crankshaft. The vibration from engine rotation will be absorbed and diluted by this Harmonic Balancer.

At present market, there are two kind of Harmonic Balancer available, one is elastic rubber inserted, and the other one is heavy viscosity silicone fluid filled. The silicone filled fluid harmonic balancer is not direct exposed to the high heat from engine with a longer usage life than elastic rubber style. However, the silicone fluid sometime will create false reading and unstable movement during balancing operation of engine. The elastic rubber harmonic balancer has better ability to provide a steady momentum for absorb the vibration. However, the elastic rubber is always exposed to the high heat from engine and moisture from wet weather. These out side influences would reduce the usage life of elastic rubber harmonic balancer and might lost the integrity of rubber during engine operation. Especial it may happen for racing application. No matter there is a tough procedure for all harmonic balancer for racing application must be approved by S.F.I for strength test and endurance test to 12,000 RPM. But it could not prevent any problem during normal operation. For a better protection for prevent possible potential dangerous in racing application, the undersigned invent an Explosion Proof Harmonic Balancer.

This patent is design a harmonic balancer with the inside diameter of outer ring is smaller than the outside diameter of hub. With this new design, the harmonic balancer under any circumstance, while the elastic rubber loose it bonding capability or the elastic rubber became fragile and lost it integrity, the out ring of this harmonic balancer would only spin between the hub and engine case. It has no access to escape from the hub and damage to others.

At present racing market, there are elastic style and fluid style of harmonic dampers for anti vibration purpose. The under-drive serpentine pulley system have been introduced and commonly adapted by the racing industry for increasing of engine horse power.

To reduce weight on rotating elements, the combination of damper and pulley have been become popular in this industry recently. However, all damper and pulley combination kits on today's market are designed with serpentine belt system with install of elastic rubber damper. This system will increase engine horse power without problem. But the material characters of elastic rubber has a notable shortage life due to constantly exposed high heat generated from engine high RPM.

The undersigned invents the damper pulley system with serpentine pulley with installation of high viscosity silicone fluid with the following design patterns as:
(1). The serpentine pulley has sealed high viscosity silicone fluid with a nodular iron inertia ring to absorb engine vibration. The higher temperature tolerance of silicone fluid compare to elastic rubber will extend the usage life forever.
(2). The longer hub and extra space below pulley allow the engine belt system at the same center line.
(3). The entire weight of fluid damper pulley is lesser than elastic rubber damper pulley which will benefit and increase engine horse power.

What I claim as my invention on the Explosion Proof Harmonic Balancer is the Inside Diameter of Outer Ring on the Balancer is Smaller Than the Hub Outside Diameter.

1. There are many various methods to prevent an explosion of harmonic balancer from high revolution and high heat in the racing industry. Some manufacturer utilized sulfated rubber to increase bonding strength. Some manufacturers use forging steel material to increase the tensile strength of the balancer. However, none of the above might actual solve the explosion problem in mechanic and practice standard points.
This invention by the undersigned to has the inside diameter of Outer Ring smaller than the outside diameter of hub allows the outer ring has no access to escape from the unit in the event of give away by the bonded elastic rubber from the high heat and high vibration at any high performance engine. The larger diameter of hub would prevent the outer ring flew out from the unit and limited it only rotated in between the hub and engine case to prevent any further damage to the engine or to the driver and any by stand.
